(19) United States
(12) Patent Application Publication
(10) Pub. No.: US 2017/0066034 A1
(43) Pub. Date: Mar. 9, 2017

(54) INDUCTION HEATING DEVICE OF BLANK

(71) Applicant: Hyundai Motor Company, Seoul (KR)

(72) Inventor: Woo Ho Yang, Incheon (KR)

(21) Appl. No.: 14/941,851

(22) Filed: Nov. 16, 2015

(30) Foreign Application Priority Data
Sep. 9, 2015 (KR) 10-2015-0127938

(51) Int. Cl. B21D 47/00; H05B 6/44; H05B 6/42; H05B 6/10

(52) U.S. Cl. CPC B21D 47/00; H05B 6/101; H05B 6/44; H05B 6/42

(57) ABSTRACT

An induction heating device of a blank is provided. The device includes an induction heating member that is disposed on a table while being spaced apart from an inducting heating target by a predetermined interval. Additionally, a power unit is configured to supply power to the induction heating member to cause the induction heating member to heat a part of the induction heating target and a cooling unit is configured to cool the induction heating member.

### CROSS-REFERENCE TO RELATED APPLICATION

This application claims priority to and the benefit of Korean Patent Application No. 10-2015-0127938 filed in the Korean Intellectual Property Office on Sep. 9, 2015, the entire contents of which are incorporated herein by reference.

### BACKGROUND

(a) Field of the Invention

The present invention relates to an induction heating device of a blank, which molds a blank by inductively heating at least a part of the blank for manufacturing a vehicle body.

(b) Description of the Related Art

Recently, to improve fuel efficiency of a vehicle, components have been developed which are light weight while maintaining high strength. Further, according to a structural characteristic of a vehicle, high strength or high toughness is required. In the related art, a method has been developed of bonding a part, which is manufactured of a heat-treated hardening steel plate and requires high strength, and a part, which is manufactured of a general steel plate and requiring relatively low strength, by welding.

However, when a heating furnace is used when the part requiring high strength is heat treated, a space for installing the heating furnace and cost for operating the heating furnace are required. Further, it may be difficult to heat a part of the steel plate by using the heating furnace.

The above information disclosed in this section is merely for enhancement of understanding of the background of the invention and therefore it may contain information that does not form the prior art that is already known in this country to a person of ordinary skill in the art.

### SUMMARY

The present invention provides an induction heating device of a blank, which is capable of more easily heating a part of a blank at a small space, decreasing production cost, and improving productivity.

An exemplary embodiment of the present invention provides an induction heating device of a blank that may include: an induction heating member spaced apart from an induction heating target by a predetermined distance to inductively heat the induction heating target; and a power unit configured to supply power to the induction heating member.

The induction heating member may be disposed to correspond to at least a part of the induction heating target. Additionally, the induction heating member may be formed in a pipe shape, and may include a flat surface that faces the induction heating target. The induction heating member may be formed along a predetermined route to correspond to one surface of the induction heating target, and two or more induction coils may be formed along routes, respectively. The two or more induction coils may be spaced apart from each other by a predetermined distance.

A coolant may flow along a center portion of the induction heating member to prevent the induction heating member from being overheated. A coolant pipe may be disposed along a center portion of the induction heating member, and a coolant may be supplied to pass through the coolant pipe. One element (e.g., a first part) that not correspond to the induction heating member of the induction heating target, may be in contact with a ceramic block, and may be fixed by a holder. The induction heating device may further include an elastic member configured to elastically support the ceramic block and a support configured to support another element (e.g., a second part), which is not in contact with the ceramic block.

Another exemplary embodiment of the present invention provides an induction heating device of a blank that may include: an induction heating member disposed on a table while being spaced apart from an inducting heating target by a predetermined interval; a power unit configured to supply power to the induction heating member to allow the induction heating member to heat a part of the induction heating target; and a cooling unit configured to cool the induction heating member.

The cooling unit may include: a coolant pipe disposed along a center portion of the induction heating member; and a coolant pump configured to pump a coolant to circulate through the coolant pipe. The induction heating device may further include an insulation member configured to insulate the induction heating target from the table and the insulation member may be a ceramic material.

### BRIEF DESCRIPTION OF THE DRAWINGS

The above and other objects, features and advantages of the present disclosure will be more apparent from the following detailed description taken in conjunction with the accompanying drawings.

FIG. 1 is a perspective view of an induction heating device of a blank according to an exemplary embodiment of the present invention;

FIG. 2 is a cross-sectional view of a part of the induction heating device of the blank according to the exemplary embodiment of the present invention;

FIG. 3 is a cross-sectional view of the induction heating device of the blank according to the exemplary embodiment of the present invention;

FIG. 4 is a plane cross-sectional view of the induction heating device of the blank according to the exemplary embodiment of the present invention; and

FIG. 5 is a side cross-sectional view of the induction heating device of the blank according to the exemplary embodiment of the present invention.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

An exemplary embodiment of the present invention will hereinafter be described in detail with reference to the accompanying drawings.

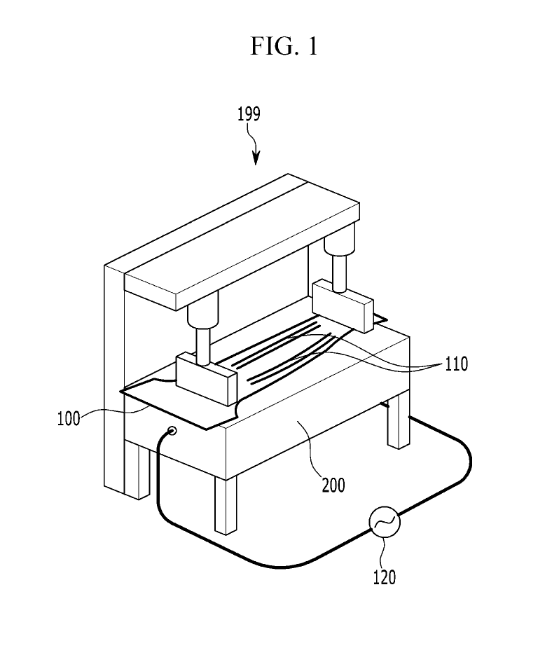

FIG. 1 is a perspective view of an induction heating device of a blank according to an exemplary embodiment of the present invention. As illustrated in FIG. 1, an induction heating device 199 of a blank according to an exemplary embodiment of the present invention is a device for inductively heating a blank 100, and may include a table 200 and a power unit 120. The blank 100 may be disposed (e.g., placed, deposited, positioned, etc.) on the table 200 of the induction heating device and the power unit 120 may be configured to apply power to heat a part of the blank 100. In particular, the heated part of the blank 100 will be referred to as a partially heated portion 110.

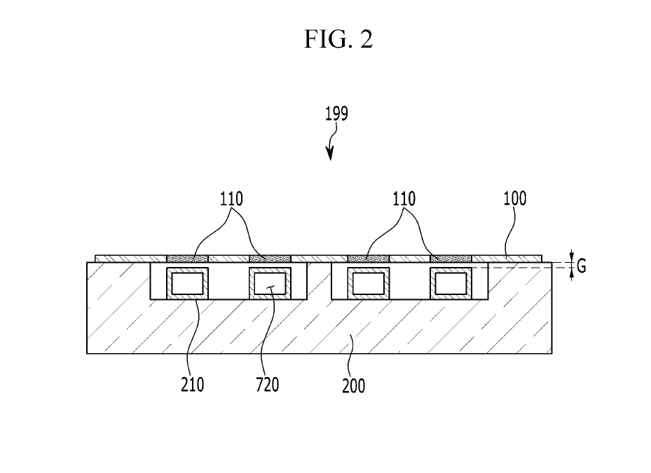

FIG. 2 is a cross-sectional view of a part of the induction heating device of the blank according to the exemplary embodiment of the present invention. As illustrated in FIG. 2, the induction heating device 199 may further include an induction coil 210 and a cooling passage 220. A predetermined gap G may be formed between a lower surface of the blank 100 and an upper surface of the induction coil 210. In particular, the gap G may be set to about 2 mm to 5 mm

When power is applied to the induction coil 210 from the power unit 120, the partially heated portion 110 of the blank 100 facing the induction coil 210 may be heated. Further, to prevent the induction coil 210 from being overheated, a coolant may be injected (e.g., pumped) to flow through a center portion of the induction coil 210. A specific part of the blank 100 may be heated to improve the strength of the specific part of the blank 100 based on a shape and an arrangement of the induction coil 210.

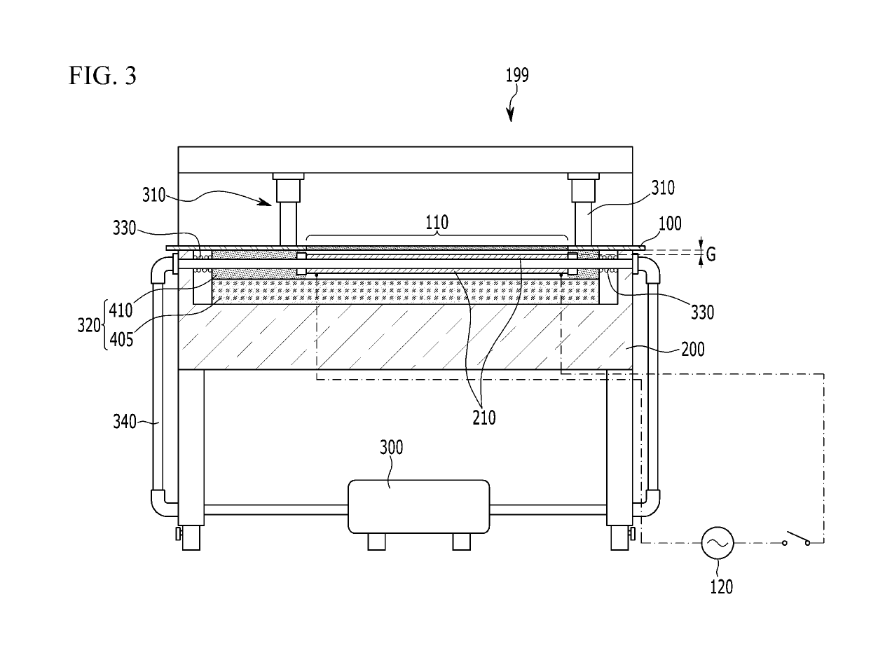

FIG. 3 is a cross-sectional view of the induction heating device of the blank according to the exemplary embodiment of the present invention. As illustrated in FIG. 3, the induction heating device 199 may further include a coolant pump 300, a coolant pipe 340, an elastic member 330, a ceramic block 320, and a holder 310. The induction coil 210 may be a copper pipe formed in a shape of a hollow pipe. Further, the power unit 120 may be configured to apply a current and voltage to both ends of the induction coil 210.

The ceramic block 320 may be disposed on an upper surface of the table 200 except for a border of the upper surface of the table 200 (e.g., not along the edges of the upper surface, but substantially in the middle thereof), and the induction coil 210 may be disposed on the ceramic block 320. The ceramic block 320 may further be formed of a ceramic material that is resistance to a high temperature to protect the table 200 and peripheral components from heat of the induction coil 210. In other words, the ceramic block 320 may operate as an insulation between the table 200 and the induction coil 210 to prevent heat from being transmitted to the table 200. The elastic member 330 may be interposed between the border of the table 200 and the ceramic block 320 to elastically support the ceramic block 320. In other words, the elastic member 330 may be configured to offset stress based on thermal expansion in a longitudinal direction or a width direction of the ceramic block 320. The elastic member 330 may have a structure, such as a hydraulic shock absorber or a spring.

Further, the holder 310 may be configured to fix the blank 100 between the ceramic block 320 and the holder 310 by pulling the upper surface of the blank 100 toward the ceramic block 320. In particular, the holder 310 may be vertically and horizontally operated to fix various forms of blank 100. The coolant pipe 340 may be disposed to pass through a hollow region of the induction coil 210. Further, the coolant pump 300 may be configured to pump a coolant to circulate the coolant to a substantially center portion of the induction coil 210 through the coolant pipe 340. Accordingly, it may be possible to prevent the induction coil 210 from being overheated, and to decrease thermal damage to the peripheral components.

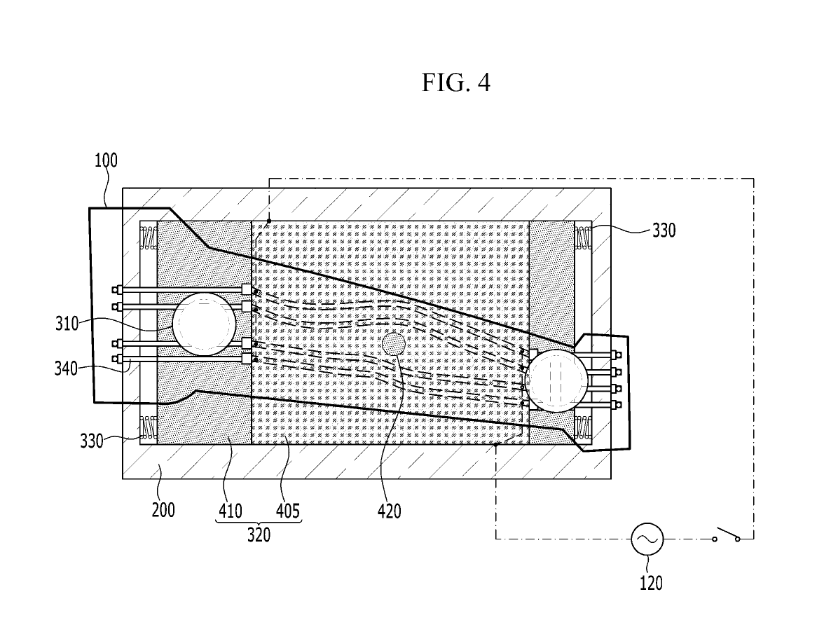

FIG. 4 is a plane cross-sectional view of the induction heating device of the blank according to the exemplary embodiment of the present invention. As illustrated in FIG. 4, the induction coil 210 may be extended in a longitudinal direction of the blank 100. Further, the induction coil 210 may be arranged in a width direction of the blank 100 with a predetermined interval. A disposition region of the induction coil 210 may be freely set. In addition, power may be applied to a part of the induction coil 210 that requires hardening, and that particular part (e.g. of the induction heating target) may be heated at a predetermined temperature.

Furthermore, the ceramic block 320 may include a first ceramic block 405 and a second ceramic block 410. The first ceramic block 405 may be a fixed type, and may be disposed to correspond to the induction coil 210. The second ceramic block 410 may be a moving type, and may be disposed on a lateral surface of the first ceramic block 405 to be elastically supported by the elastic member 330. The induction coil 210 may be arranged in the width direction of the blank 100 to heat the center portion of the blank 100 in the longitudinal direction of the blank 100. However, the induction coil 210 is not limited thereto, and may be disposed to heat a border of the blank 100 based on different designs.

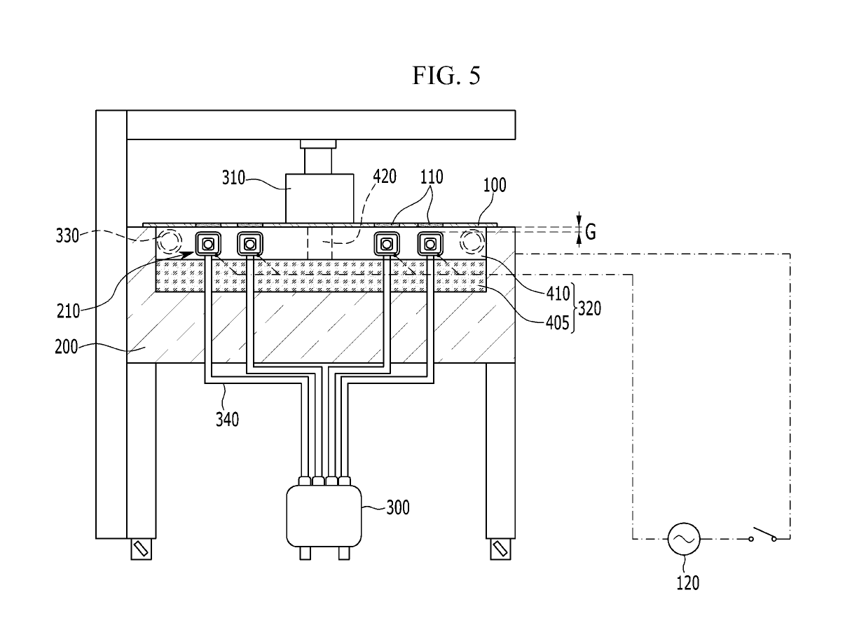

FIG. 5 is a side cross-sectional view of the induction heating device of the blank according to the exemplary embodiment of the present invention. As illustrated in FIG. 5, a support 420 may be disposed between the lower surface of the blank 100 and an upper surface of the first ceramic block 405, and the holder 310 may be disposed to correspond to the support 420. The holder 310 may be configured to fix the blank 100 to the support 420 by pressing the blank 100 in a downward direction. A position of the support 420 may be changed based on a disposition region of the induction coil 210, and a position of the holder 310 may be changed based on a position of the support 420. In addition, the coolant may be in contact with an internal surface of the induction coil 210 to exchange heat with the induction coil 210, or cool air between the induction coil 210 and the coolant pipe 340.

According to the exemplary embodiment of the present invention, it may be possible to more easily heat a predetermined region of the blank 100 using the induction coil 210 without a separate heating furnace. Accordingly, production cost may be reduced and productivity may be improved by designing the induction coil 210 to be applied to various types of vehicles.

While this invention has been described in connection with what is presently considered to be exemplary embodiments, it is to be understood that the invention is not limited to the disclosed exemplary embodiments, but, on the contrary, is intended to cover various modifications and equivalent arrangements included within the spirit and scope of the appended claims.

What is claimed is:

1. An induction heating device of a blank, comprising:
an induction heating member spaced apart from an induction heating target by a predetermined distance to inductively heat the induction heating target; and
a power unit configured to supply power to the induction heating member.

2. The induction heating device of claim 1, wherein the induction heating member is disposed to correspond to at least a part of the induction heating target.

3. The induction heating device of claim 1, wherein the induction heating member is formed in a pipe shape, and includes a flat surface that faces the induction heating target.

4. The induction heating device of claim 1, wherein:
the induction heating member is formed along a predetermined route to correspond to one surface of the induction heating target, and
two or more induction coils are formed along routes, respectively, and the two or more induction coils are spaced apart from each other by a predetermined distance.

5. The induction heating device of claim 2, wherein a coolant flows along a center portion of the induction heating member to prevent the induction heating member from being overheated.

6. The induction heating device of claim 1, wherein a coolant pipe is disposed along a center portion of the induction heating member, and a coolant is supplied to pass through the coolant pipe.

7. The induction heating device of claim 2, wherein a first part of the induction heating target which does not correspond to the induction heating member of the induction heating target, is in contact with a ceramic block, and is fixed by a holder.

8. The induction heating device of claim 7, further comprising:
an elastic member configured to elastically support the ceramic block.

9. The induction heating device of claim 7, further comprising:
a support configured to support a second part, which is not in contact with the ceramic block.

10. The induction heating device of claim 8, wherein in the ceramic block includes a first ceramic block and a second ceramic block, the first ceramic block being a fixed type and disposed to correspond to an induction coil and the second ceramic block being a moving type and disposed on a lateral surface of the first ceramic block to be elastically supported by the elastic member.

11. An induction heating device of a blank, comprising:
an induction heating member disposed on a table and spaced apart from an inducting heating target by a predetermined interval;
a power unit configured to supply power to the induction heating member to heat a first part of the induction heating target; and
a cooling unit configured to cool the induction heating member.

12. The induction heating device of claim 11, wherein the cooling unit includes:
a coolant pipe disposed along a center portion of the induction heating member; and
a coolant pump configured to pump a coolant to circulate the coolant through the coolant pipe.

13. The induction heating device of claim 11, further comprising:
an insulation member configured to insulate the induction heating target from the table.

14. The induction heating device of claim 13, wherein the insulation member is a ceramic material.
